(19) United States
(12) Patent Application Publication
(10) Pub. No.: US 2025/0147962 A1
(43) Pub. Date: May 8, 2025

(54) Optimizing Vector Embedding Representations of Time-Series Information via Frequency Domain Representations

(71) Applicant: KX Systems, Inc., New York, NY (US)

(72) Inventors: Paul Colgan, New York, NY (US); Sam Bruce, New York, NY (US); Andrew Morrison, New York, NY (US)

(21) Appl. No.: 18/936,361

(22) Filed: Nov. 4, 2024

Related U.S. Application Data
(60) Provisional application No. 63/595,639, filed on Nov. 2, 2023.

(51) Int. Cl. G06F 16/2453; G06F 16/2455

(52) U.S. Cl. CPC G06F 16/24544; G06F 16/2455

(57) ABSTRACT

A set of time-series information descriptive of one or more events occurring within a particular period of time is obtained. A frequency domain transformation is applied to the set of time-series information to obtain a frequency-domain representation of the set of time-series information comprising a plurality of frequency components. A dimensionally-reduced frequency-domain representation of the set of time-series information is determined based at least in part on a first subset of frequency components of the plurality of frequency components.

### PRIORITY CLAIM

The present application claims priority to, and the benefit of, U.S. Provisional Patent Application No. 63/595,639, having a filing date of Nov. 2, 2023. Applicant incorporates the application herein by reference in its entirety.

### FIELD

The present disclosure relates generally to vector-based databases. More particularly, the present disclosure relates to optimizing vector representations of time-series information by representing time-series information in the frequency domain.

### BACKGROUND

Vector embeddings are numerical representations of words, sentences, video, images, audio, or any other type of information. Vector embeddings are used in machine learning, such as Large Language Models (LLMs), to facilitate efficient analysis and manipulation of any kind of unstructured data. By converting unstructured data into vector embeddings, machine-learned models can efficiently and accurately perform tasks such as querying, classification, and applying machine learning algorithms on unstructured data.

### SUMMARY

Aspects and advantages of embodiments of the present disclosure will be set forth in part in the following description, or can be learned from the description, or can be learned through practice of the embodiments.

One example aspect of the present disclosure is directed to a method, The method includes obtaining, by a computing system comprising one or more processor devices, a set of time-series information descriptive of one or more events occurring within a particular period of time. The method includes applying, by the computing system, a frequency domain transformation to the set of time-series information to obtain a frequency-domain representation of the set of time-series information comprising a plurality of frequency components. The method includes determining, by the computing system, a dimensionally-reduced frequency-domain representation of the set of time-series information based at least in part on a first subset of frequency components of the plurality of frequency components.

Another example aspect of the present disclosure is directed to a computing system, including one or more processors and one or more non-transitory computer-readable media that store instructions that, when executed by the one or more processors, cause the computing system to perform operations. The operations include obtaining a set of time-series information descriptive of one or more events occurring within a particular period of time. The operations include applying a Fast Fourier Transform (FFT) to the set of time-series information to obtain the frequency-domain representation of the set of time-series information comprising the plurality of frequency components, and wherein each of the plurality of frequency components comprises a complex number pair of a corresponding plurality of complex number pairs. The operations include selecting a first subset of frequency components from the plurality of frequency components based on a frequency value of each of the first subset of frequency components, wherein the frequency value of each of the first subset of frequency components is less than a threshold frequency value. The operations include performing a pairwise join to each of the complex number pairs of the first subset of frequency components to obtain the dimensionally-reduced frequency-domain representation of the set of time-series information, wherein the dimensionally-reduced frequency-domain representation comprises a one-dimensional vector of real numbers.

Another example aspect of the present disclosure is directed to one or more non-transitory computer-readable media that store instructions that, when executed by one or more processors of a computing system, cause the computing system to perform operations. The operations include obtaining a set of time-series information descriptive of one or more events occurring within a particular period of time. The operations include using a Fast Fourier Transform (FFT) to convert the set of time-series information to a frequency-domain representation of the set of time-series information comprising a plurality of frequency components. The operations include determining a vector representation of the frequency-domain representation of the set of time-series information.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a block diagram of an environment suitable for optimizing vector representations of time-series information by representing time-series information from the frequency domain according to some implementations of the present disclosure.

FIG. 2 is a data flow diagram for providing vector embeddings as a service according to some implementations of the present disclosure.

FIG. 3 is a flowchart for optimizing vector representations of time-series information by representing time-series information from the frequency domain according to some implementations of the present disclosure.

FIG. 4 depicts a block diagram of an example computing system that provides vector embedding services according to example implementations of the present disclosure.

Reference numerals that are repeated across plural figures are intended to identify the same features in various implementations.

### DETAILED DESCRIPTION

### Overview

Generally, the present disclosure is directed to vector-based databases. More particularly, the present disclosure relates to optimizing vector representations of time-series information by representing time-series information from the frequency domain. Conventionally, vector embeddings can be utilized to represent time-series information. Time-series information, as described herein, refers to a set of information that includes some temporal aspect or component. For example, time-series information may include a series of timestamped reports from an Internet-of-Things (IOT) device that is configured to report at a certain frequency. For another example, time-series information can include numerical univariate data (e.g., discrete univariate data, continuous univariate data, etc.).

Vector embeddings can act as a lower-dimensional representation of such time-series information. To generate representative vector embeddings, time-series information may be processed with an embedding model trained to generate vector representations of time-series information. Alternatively, some other process may be utilized to generate a vector or some other type of embedding that represents the time-series information. For example, a sliding window transformation may be applied to time-series information to extract relevant features for inclusion in an embedding. Vector representations provide the benefit of mitigating the “curse of dimensionality” problem, in which the number of training data required to train a model grows exponentially with the number of features or dimensions.

Vector representations of time-series information can be embedded in an embedding space. More specifically, a vector representation can be mapped to a particular location within an embedding space. As described herein, an embedding space refers to a relatively low-dimensional space into which high-dimensional vector representations can be mapped. Generally, a distance between embeddings in an embedding space can represent a similarity between the embeddings. In other words, the closer two embeddings are in an embedding space, the more similar they are. Alternatively, a “shape” of a vector representation can be identified in an embedding space, and spatial similarity between vector representations can be utilized to infer similarity between time-series information. For example, if two sets of time-series information both form a similar shape when graphed, the vector representation can reflect this spatial similarity even when a conventional embedding technique would not.

Conventional vectorization approaches generally represent time-series information from the time domain. In other words, conventional vectorization approaches generate vector representations of time-series information as a function of time. However, these conventional approaches present a number of challenges. As one example, these approaches generally produce large vectors that can require large quantities of memory, processing, and storage resources to handle. As another example, these approaches can “over-represent” time-series information in certain instances. In other words, the vectors can include more information than necessary, thus being less than optimal for compression tasks or similar. As yet another example, these approaches can limit comparisons between sets of time-series information to those that are equivalent in length, thus requiring additional pre-processing steps to normalize sets of varying length time-series information for subsequent comparison.

Accordingly, implementations of the present disclosure are directed to optimizing vector representations of time-series information by representing time-series information from the frequency domain. For example, assume that a computing system provides vector embedding services that leverage a time-series database, such as a hybrid time-series vector database. As described herein, a hybrid vector database refers to a database that stores both vectorized information and non-vectorized information to enable hybrid search operations, which can provide more accurate results than conventional databases. A time-series vector database refers to a database storing vector representations that represent temporal information.

The computing system can obtain a set of time-series information. The set of time-series information can describe one or more events occurring within a particular period of time. For example, the set of time-series information can describe a series of timestamped sensor readings from an IoT device. For another example, the set of time-series information can describe a series of financial transactions occurring over a period of time. In some implementations, the set of time-series information can be a real-time stream of time-series information.

The computing system can apply a frequency domain transformation to the set of time-series information to obtain a frequency-domain representation of the set of time-series information. More specifically, the computing system can apply some type or manner of transformation, process, algorithm, etc. to convert a time-domain representation of the time-series information to a frequency-domain representation of the time-series information. For example, the computing system can apply a Fast Fourier Transform (FFT) to the set of time-series information to obtain the frequency-domain representation of the time-series information. Additionally, or alternatively, in some implementations, the computing system can apply dimensionality reduction process(es), such as a Principal Component Analysis (PCA), Exponential Moving Average (EMA), etc, to reduce dimensionality before, or after, converting from the time domain to the frequency domain.

The frequency-domain representation of the time-series information can include a plurality of frequency components. More specifically, the frequency-domain representation can include a vector of complex pairs (e.g., pairs of complex number components). Each frequency component of the frequency-domain representation can include, or can correspond to, one or more of the complex pairs.

In some implementations, the computing system can select a first subset of frequency components from the frequency-domain representation. Specifically, the computing system can select a set of frequency components with a frequency value that is lower than a threshold frequency value. In other words, the first subset of frequency components can be “lower” frequency components in comparison to other “higher” frequency components of the representation. In this manner, the first subset of frequency components can represent “macro” movements represented by longer wavelengths within the frequency-domain representation.

Once the frequency-domain representation of the set of time-series information is obtained, the computing system can determine a dimensionally-reduced frequency-domain representation of the set of time-series information based at least in part on the first subset of frequency components of the plurality of frequency components. For example, the first subset of frequency components can be, or otherwise include, the complex pairs that correspond to the first subset of frequency components. The computing system can perform a pairwise join to the paired components (e.g., the pair of real and imaginary numbers) of each of the complex numbers to obtain a one-dimensional vector of real numbers. Each element of the vector can represent the “impact” of a particular frequency mode. In such fashion, implementations of the present disclosure can optimize the manner in which time-series information is represented.

Aspects of the present disclosure provide a number of technical effects and benefits. As one example technical effect and benefit, implementations of the present disclosure can substantially reduce the quantity of compute resources required to implement hybrid vector time-series databases. Specifically, implementations described herein can determine a frequency-domain representation of a set of time-series information, and can then generate a dimensionally-reduced frequency-domain representation of the set of time-series information, such as a vector. In many instances, this dimensionally-reduced frequency-domain representation can sufficiently represent the set of time-series information while being substantially smaller than a conventional vector representation, thus reducing the compute resources required to store and utilize such vectors (e.g., power, memory, processing cycles, storage, etc.).

As another example, implementations of the present disclosure can facilitate more accurate comparisons of time-series information. More specifically, dimensionally-reduced frequency-domain representations generated as described herein can provide more accurate results than conventional approaches. For example, the dimensionally-reduced frequency-domain representations enable similarity searches that focus primarily on the general shape of the data, rather than minimizing the error between sets of point, which in turn leads to more accurate performance for retrieval tasks by returning results with similar geometric and/or spatial characteristics that may be overlooked by conventional search techniques. For another example, the dimensionally-reduced frequency-domain representations enable improved retrieval speeds due to similarity searches being conducted between shorter length vectors, improved disk/memory utilization due to shorter length vectors, improved scalability as an increase in dimensionality can still be reduced to a fixed size of embedding, lower error between query and result vectors, etc. Finally, the dimensionally-reduced frequency-domain representations described herein enable comparisons between buckets of timeseries data that aren't equivalent in length, as each bucket will be reduced to a representation of their frequency components.

It should be noted that, as described herein, “the frequency domain” or “the frequency representation” can refer to a number of different mathematical transforms which are used to analyze time-domain functions and are referred to as “frequency domain” methods. As such, the phrase “frequency domain” does not imply utilization of any particular type or manner of transform. For example, a “frequency domain” in the context of periodic time-series information may refer to an FFT frequency domain, while in the context of electronic circuits and control systems, the “frequency domain” may refer to an laplace transform frequency domain.

With reference now to the Figures, example embodiments of the present disclosure will be discussed in further detail.

### Example Devices and Systems

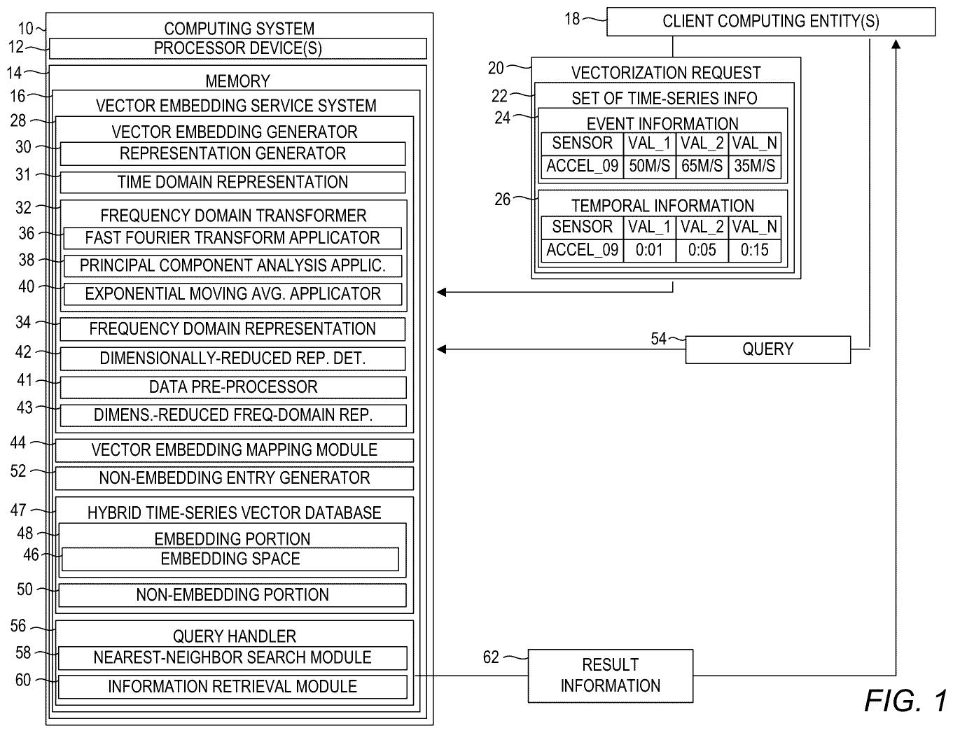

FIG. 1 is a block diagram of an environment suitable for optimizing vector representations of time-series information by representing time-series information from the frequency domain according to some implementations of the present disclosure. A computing system 10 includes processor device(s) 12 and memory 14. In some implementations, the computing system 10 may be a computing system that includes multiple computing devices. Alternatively, in some implementations, the computing system 10 may be one or more computing devices within a computing system that includes multiple computing devices. Similarly, the processor device(s) 12 may include any computing or electronic device capable of executing software instructions to implement the functionality described herein.

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can, in some implementations, include a containerized unit of software instructions (i.e., a “packaged container”). A containerized unit of software instructions can collectively form a container that has been packaged using any type or manner of containerization technique.

The memory 14 can include a vector embedding service system 16. The vector embedding service system 16 can be a system (e.g., hardware, software, containerized software, compute resources, etc.) that implements, orchestrates, and/or provides vector embedding services. As described herein, a vector embedding services refers to a service that can generate a vector representation of an input in response to a vectorization request for storage in a database (e.g., a vector database, a hybrid vector database, a hybrid time-series vector database, etc.). In addition, the vector embedding service can enable queries to the vector database. For example, in response to a query, the vector embedding service can perform a nearest neighbor search based on a vector representation of the query.

The vector embedding service system 16 can enable large-scale parallelized connections handling. More specifically, the vector embedding service system 16 can field requests from large numbers of clients concurrently. For example, the vector embedding service system 16 can implement a multi-tenant vector database in which multiple clients access a database that is partitioned on a per-client basis. In turn, to support the multi-tenant database, the vector embedding service system can support large-scale parallelized connection handling.

To do so, the vector embedding service system 16 can include a connection module. The connection module can manage active connections between the vector embedding service system 16 and client computing entities 18. Specifically, the connection module can implement sockets. The sockets can be utilized to facilitate active connections between the vector embedding service system 16 and the client computing entities 18. The sockets can be implemented using any type or manner of networking protocols or technologies. For example, the sockets can be Transmission Control Protocol (TCP) sockets that include an Internet Protocol (IP) address and a corresponding port.

The vector embedding service system 16 can receive a vectorization request 20 from the client computing entity(s) 18. The vectorization request 20 can be, or otherwise include, a request to generate vector representation for a particular input. Specifically, the vectorization request 20 can request that the vector embedding service system 16 generate a vector representation for a set of time-series information 22. The set of time-series information 22 can be an input for storage in a database, or databases, by the vector embedding service system 16. Alternatively, the set of time-series information 22 can be vectorized and the vector representation can be provided to the client computing entity(s) 18 that provided the vectorization request 20.

In some implementations, the set of time-series information 22 can include event information 24. The event information 24 can be, or otherwise include, information descriptive of event(s) that occurred at a specific time or over a specific time period. For example, assume an accelerometer sensor is programmed to begin measuring the acceleration of a computing device every ten minutes. The event information 24 can describe one of the measurement iterations that occurs every ten minutes. Specifically, the event information 24 can include the measurements captured during that particular measurement iteration. For example, if the accelerometer sensor is programmed such that, every ten minutes, the accelerometer sensor measures an acceleration of a computing device at a frequency of one measurement per second for a duration of 5 seconds, the event information 24 can include five measurements generated by the accelerometer.

It should be noted that the set of time-series information 22 can be, or otherwise include, a file or other information that does not necessarily correspond to a particular event. For example, the event information 24 can be a conventional type or manner of media, such as textual content (e.g., a file such as .epub, .docx, .txt, .rtf, etc.), or another miscellaneous type of data (e.g., spreadsheet data such as an .xml file, a slideshow such as a .ppt file, etc.). Additionally, or alternatively, in some implementations, the time-series information 22 can be time-series information that is derived from a conventional type or manner of media (e.g., video data, image data, etc.).

The set of time-series information 22 can include temporal information 26. The temporal information 26 can be, or otherwise include, information descriptive of particular temporal characteristics of the event information 24. To follow the previous example, if the accelerometer sensor measures an acceleration of a computing device at a frequency of one measurement per second for a duration of 5 seconds, the temporal information 26 can describe a starting time of the measurement duration, an ending time of the measurement duration, and a specific timestamp for each of the five measurements captured. In such fashion, the temporal information 26 can be utilized to populate a hybrid time-series vector database with rich information.

The vectorization request 20 can be received by the computing system 10 via the sockets. Upon receipt, the vector embedding service system 16 can process the vectorization request 20 with a vector embedding generator 28. The vector embedding generator 28 can generate vector representations of inputs, such as the set of time-series information 22.

The vector embedding generator 28 can include a representation generator 30. The representation generator 30 can generate intermediate representations of the set of time-series information 20. For example, the representation generator 30 can be a machine-learned embedding model, such as a transformer model, that is trained to generate vector dimensional representations of inputs. In some implementations, the representation generator 30 can generate a time domain representation 31 of the set of time-series information 22.

For a specific example, if the set of time-series information 22 is a file including the textual content of a novel, the machine-learned embedding model can process the set of time-series information 22 to generate a vector representation of the set of time-series information 22. Alternatively, the representation generator 30 can generate a vector representation of the set of time-series information 20 in some other manner. For example, the representation generator 30 can generate a vector representation of the set of time-series information 20 by performing a sliding window transformation to the set of time-series information 20.

Additionally, or alternatively, the vector embedding generator 28 can include a frequency domain transformer 32. The frequency domain transformer 32 can transform the set of time-series information 20 from the time domain to the frequency domain. Specifically, in some implementations, the frequency domain transformer 32 can apply a frequency domain transformation to the set of time-series information 20 to obtain a frequency-domain representation 34 of the set of time-series information 20. Alternatively, in some implementations, the frequency domain transformer 32 can apply a frequency domain transformation to the time domain representation 31 to obtain the frequency-domain representation 34 of the set of time-series information 20.

As described herein, a frequency domain transformation can refer to any type or manner of technique, algorithm, process, or collection thereof that can transform information from a time domain representation to a frequency domain representation. For example, the frequency domain transformer 32 can include a Fast Fourier Transform (FFT) applicator 36. The FFT applicator 36 can apply an FFT to the set of time-series information 20 to obtain the frequency domain representation 34.

Additionally, or alternatively, in some implementations, the frequency domain transformer 32 can apply some other type of transformation to the time-series information 20 to obtain the frequency domain representation 34. For example, the frequency domain transformer 32 can apply a wavelet transform. A wavelet transform can be utilized for time-frequency analysis, and in particular, when the frequency content of a signal varies with time. For another example, the frequency domain transformer 32 can apply a a laplace transform. A laplace transform can be used to convert signals from the time domain from the frequency domain. For another example, the frequency domain transformer 32 can apply a Z-transform. A Z-transform can be utilized to convert discrete-time signals into the frequency domain. For another example, the frequency domain transformer 32 can apply a Hilbert transform. A Hilbert transform can be utilized to obtain the analytic signal of a real-valued signal. For another example, the frequency domain transformer 32 can apply a Chirplet transform. A “Chirplet” refers to a generalization of the wavelet that can adapt to both the frequency and rate of change of frequency in a signal, and as such, a Chirplet transform can be utilized to analyze signals with varying frequency components. For yet another example, the frequency domain transformer 32 can apply a Continuous Wavelet Transform (CWT), etc. A CWT can be utilized for time-frequency analysis and can capture localized frequency information in a signal.

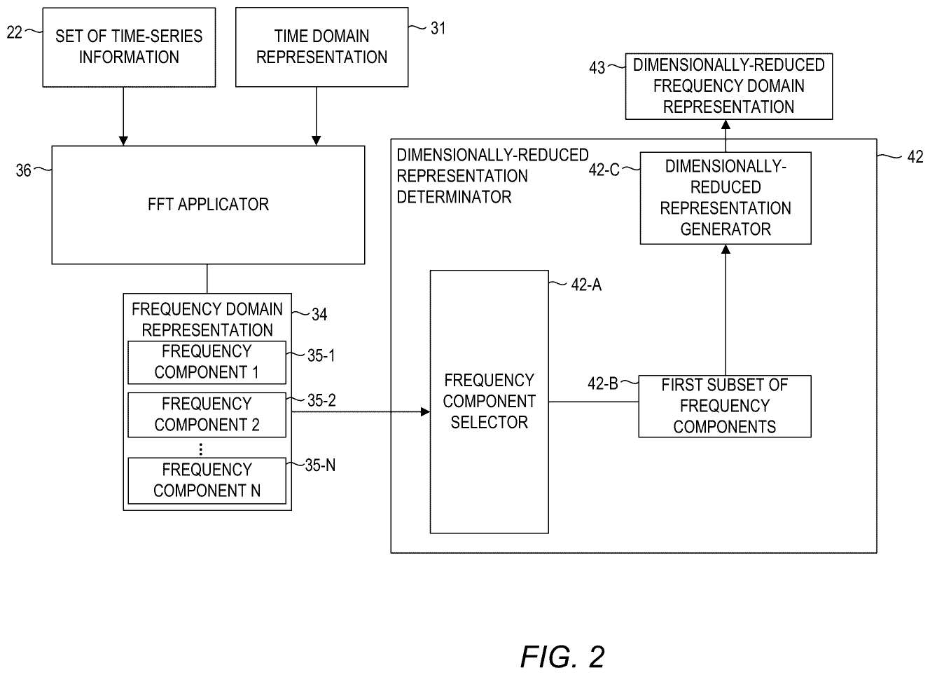

In some implementations, the frequency domain transformer 32 can perform dimensionality reduction techniques to reduce the dimensionality of the time domain representation 31 and/or the frequency domain representation 34. For example, the frequency domain transformer can include a Principal Component Analysis (PCA) applicator 38. The PCA applicator 38 can perform a PCA to the set of time-series information 20, the time domain representation 31, and/or the frequency domain representation 34, before, or after, the frequency domain representation 34 is generated to reduce dimensionality. For yet another example, the frequency domain transformer 32 can include an Exponential Moving Average (EMA) applicator 40. The EMA applicator 40 can perform an EMA to the set of time-series information 20, the time domain representation 31, and/or the frequency domain representation 34, before, or after, the frequency domain representation 34 is generated to reduce dimensionality. The frequency domain transformer 32 will be discussed in greater detail with regards to FIG. 2.

In some implementations, prior to processing the set of time-series information 22, the vector embedding service system 16 can process the set of time-series information 22 with a data pre-processor 41. The data pre-processor 41 can perform various data preprocessing tasks, such as normalization, replacing null values, performing seasonal adjustments, etc. For example, assume that the set of time-series information 22 includes an array of values. The data pre-processor 41 can identify one of those values as being a null value. The data pre-processor 41 can determine an average value based on values located relatively close to the null value. For example, if the null value is the i^{th} value in the array, the data pre-processor 41 can determine an average based on the values of the array located at i−1 and i+1. In other words, the data pre-processor 41 can determine the average value based on values located prior to the null value and/or values located subsequent to the first value. The data pre-processor 41 can then replace the null value with the average value.

In some implementations, the data pre-processor 41 can determine whether the set of time-series information 22 is stationary. For example, the data pre-processor 41 can perform a data stationarity test to determine that the set of time-series information 22, or at least the temporal information 26, is stationary.

The vector embedding generator 28 can include a dimensionally-reduced representation determinator 42. The dimensionally-reduced representation determinator 42 can determine a dimensionally-reduced frequency domain representation 43 of the set of time-series information 20. Specifically, the dimensionally-reduced representation determinator 42 can determine a reduced-dimension representation of the frequency domain representation 34. For example, assume that the frequency domain representation 34 includes a plurality of frequency components. Each frequency component can be, include, or otherwise be derived from one or more complex numbers.

The dimensionally-reduced representation determinator 42 can select a subset of the frequency components with lower frequency values. The dimensionally-reduced representation determinator 42 can convert the subset of frequency components to a one-dimensional (1D) array of real numbers by performing a pairwise join of the real and imaginary numbers included in each frequency component. The 1D array of real numbers can be utilized as the dimensionally-reduced frequency domain representation 43. The dimensionally-reduced representation determinator 42 will be discussed in greater detail with regards to FIG. 2.

The vector embedding service system 16 can include a vector embedding mapping module 44. The vector embedding mapping module 44 can map vector embeddings generated by the vector embedding generator 28 to an embedding space 46. More specifically, assume that the vector embedding service system 16 implements a hybrid vector database 47. The hybrid vector database 47 can include an embedding portion 48 and a non-embedding portion 50. The non-embedding portion 50 can store database entries in a non-encoded format. In other words, the non-embedding portion 50 can store information in accordance with conventional database techniques. Conversely, the embedding portion 48 can store embeddings generated using the vector embedding generator 28 to implement vector database services.

To do so, the embedding portion 48 of the hybrid time-series vector database 47 can include the embedding space 46. The embedding space 46 can be a lower-dimensional deterministic space to which higher-dimensional vectors can be mapped. In particular, vectors can be embedded to a particular location within the embedding space 46. The embedding space can be a learned embedding space (e.g., learned in conjunction with the machine-learned vector embedding model 42, etc.) such that the location of a vector within the embedding space 46 can be based on the values of certain dimensions of the vector. In other words, the distance between similar vectors within the embedding space 46 can be less than the distance between dissimilar vectors within the embedding space 46.

Conversely, the vector embedding service system 16 can include a non-embedding entry generator 52 to generate database entries for the non-embedding portion 50. The non-embedding entry generator 52 can process the vectorization request 20 to generate a corresponding database entry for the non-embedding portion 50. To follow the depicted example, the non-embedding entry generator 52 may generate an entry for the set of time-series information 22 that stores the type and identification of the sensor (e.g., accelerometer ACCEL_09) a database entry ID, and the corresponding vector representation or a pointer to the vector representation.

The client computing entities 20 can provide the vectorization request to the vector embedding service system 16. In response, the vector embedding service system 16 can generate vector representations for each of the inputs. Once vectorized, the client computing entities 20 can provide a query 54 to the vector embedding service system 16. The query 54 can be a query for the hybrid time-series vector database 47.

For example, the query 53 can include a textual query. The vector embedding service system 16 can include a query handler 56. The query handler 56 can generate a query vector representation of the query using the vector embedding generator 28. The query handler 56 can then perform a nearest-neighbor search of the embedding space 46 with a nearest neighbor search module 58 to identify the vector representation of the set of time-series information 22.

The query handler 56 can retrieve the information that corresponds to the vector representation of the set of time-series information 22 using an information retrieval module 60. For example, upon receipt of the vectorization request 20, the vector embedding service system 16 can generate an embedding of the set of time-series information 22 with the vector embedding generator 28 and can map the vector to the embedding space 46 with the vector embedding mapping module 44. The vector embedding service system 16 can also store an association between the vector representation of the set of time-series information 22 and the event information 24/temporal information 26. In other words, the vector embedding service system 16 can associate the vector generated from the set of time-series information 22 with the event information 24 and the temporal information 26.

The vector embedding service system 16 can search the embedding space based on the query 54 to identify the similar vector(s) from the set of time-series information 22. The vector embedding service system 16 can then retrieve the event information 24 and the temporal information 26 based on an association with the vector. The event information 24 and the temporal information 26 can then be provided to the client computing device(s) 18 that provided the query 54. More specifically, the vector embedding service system 16 can generate result information 62. The result information 62 can include, or otherwise be derived from, the event information 24 and/or the temporal information 26. The result information 62 can be provided to the client computing device(s) 20 that provided the query 56. It should be noted that, when searching the embedding space based on the query 54, the vector embedding service system 16 can retrieve multiple similar vector(s) based on a similarity between the result vector(s) and the query, and/or the number of results specified (i.e., the number of “nearest neighbors” specified).

In some implementations, the vector embedding service system 16 can retrieve vector(s) similar to the query vector based on a spatial, or geometric, similarity between the information represented by the embeddings. For example, assume that the information represented by a query vector and a result vector appears spatially/geometrically similar when plotted on a graph. The query and result vector embeddings can capture this spatial/geometric appearance when generated. In this manner, the result vector can be selected due to the similarities between the spatial/geometric “shapes” of the information represented by the result vector and the information represented by the query vector.

FIG. 2 is a data flow diagram for providing vector embeddings as a service according to some implementations of the present disclosure. FIG. 2 will be discussed in conjunction with FIG. 1. Specifically, a set of time-series information 22 can be obtained as described with regards to FIG. 1. The set of time-series information 22 can be processed with the FFT applicator 36 to obtain a frequency domain representation 34. More specifically, the FFT applicator 36 can apply an FFT to the set of time-series information 22 to obtain the frequency domain representation 34. Alternatively, the FFT applicator 36 can apply an FFT to the time domain representation 31 to obtain the frequency domain representation 34.

The frequency domain representation 34 can include frequency components 35-1-35-N (generally, frequency components 35). The frequency components 35 can be complex pairs (e.g., pairs of real and imaginary numbers) that represent particular frequency modes of the representation. The dimensionally-reduced representation determinator 42 can process the frequency domain representation 34 to obtain a dimensionally-reduced frequency domain representation 43. To do so, the dimensionally-reduced representation determinator 42 can first process the frequency domain representation 34 with a frequency component selector 42-A. The frequency component selector 42-A can select a subset of frequency components 42-B from the frequency components 45. For example, the frequency component selector 42-A can select frequency components with frequency values that are less than a threshold frequency value. In other words, the frequency component selector 42-A can select those frequency components with a “lower” frequency. In such fashion, the frequency component selector 42-A can select a subset 42-B that ignores higher frequency components to focus on the “macro” movements captured by longer wavelengths.

In some implementations, the subset of frequency components 42-B can be utilized as the dimensionally-reduced frequency domain representation 43. Alternatively, in some implementations, the subset of frequency components 42-B can be processed with a dimensionally-reduced representation generator 42-C to generate the dimensionally-reduced frequency domain representation 43. For example, as described previously, each of the frequency components of the subset of frequency components 42-B can include a complex number. The dimensionally-reduced representation generator 42-C can perform a pairwise join to each of the pairs of complex number components of each complex number of the first subset of frequency components 42-B to obtain a 1D array of real numbers. For example, a frequency component that is a complex number 1-1i can result in a pair of real values 1, −1. The ID array of real numbers can be utilized as the dimensionally-reduced frequency domain representation 43.

In some implementations, the dimensionally-reduced representation determinator 42 can convert the frequency components from one form to another form. For example, if the frequency component 35-1 is a pair of complex number components in cartesian form, the dimensionally-reduced representation determinator 42 can convert the pair of numbers to a polar form when selecting the frequency component for inclusion in the first subset of frequency components 42-B. Additionally, or alternatively, in some implementations, the dimensionally-reduced representation determinator 42 can normalize the dimensionally-reduced frequency domain representation 43. For example, assume that the dimensionally-reduced frequency domain representation 43 is a vector of values. Following the pairwise join operation, the dimensionally-reduced representation generator 42-C can normalize each of the values of the dimensionally-reduced frequency domain representation 43 between −1 and 1. In this manner, the dimensionally-reduced frequency domain representation 43 can further optimize subsequent search operations.

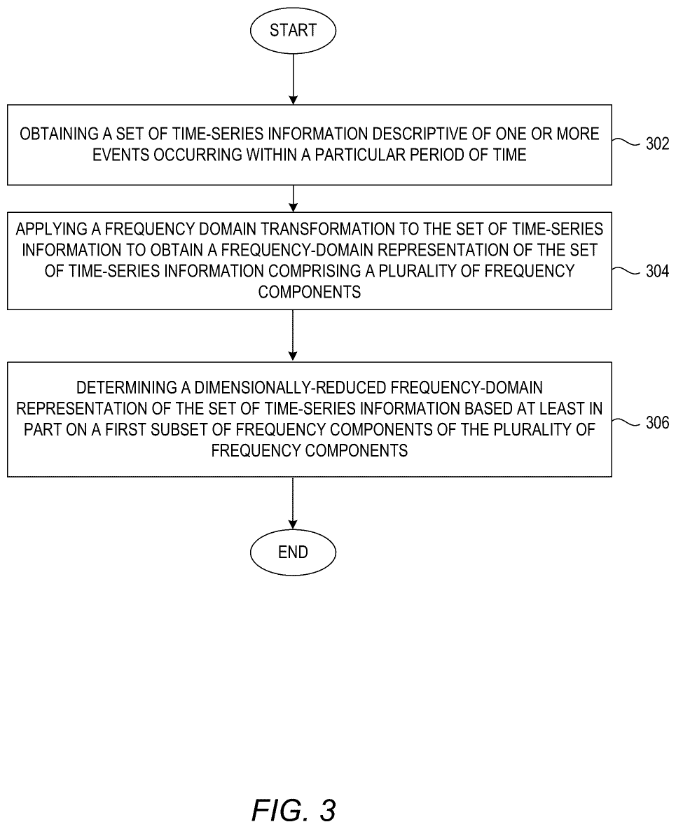

FIG. 3 is a flowchart for optimizing vector representations of time-series information by representing time-series information from the frequency domain according to some implementations of the present disclosure. Although FIG. 3 depicts steps performed in a particular order for purposes of illustration and discussion, the methods of the present disclosure are not limited to the particularly illustrated order or arrangement. The various steps of the method can be omitted, rearranged, combined, and/or adapted in various ways without deviating from the scope of the present disclosure.

At operation 302, a computing system can obtain a set of time-series information descriptive of one or more events occurring within a particular period of time.

At operation 304, the computing system can apply a frequency domain transformation to the set of time-series information to obtain a frequency-domain representation of the set of time-series information that includes a plurality of frequency components.

In some implementations, applying the frequency domain transformation can include applying a FFT to the set of time-series information to obtain the frequency-domain representation of the set of time-series information including the plurality of frequency components. Each of the plurality of frequency components can be, or otherwise include, a complex number of a corresponding plurality of complex numbers.

At operation 306, the computing system can determine a dimensionally-reduced frequency-domain representation of the set of time-series information based at least in part on a first subset of frequency components of the plurality of frequency components.

In some implementations, determining the dimensionally-reduced frequency-domain representation of the set of time-series information can include selecting the first subset of frequency components based on a frequency value of each of the first subset of frequency components. The frequency value of each of the first subset of frequency components is less than a threshold frequency value.

In some implementations, determining the dimensionally-reduced frequency-domain representation of the set of time-series information includes performing a pairwise join to each of the complex number pairs of the first subset of frequency components to obtain the dimensionally-reduced frequency-domain representation of the set of time-series information. The dimensionally-reduced frequency-domain representation can include a one-dimensional vector of real numbers.

In some implementations, the computing system can map the dimensionally-reduced frequency-domain representation to a location within an embedding space.

In some implementations, the computing system can map a vector representation of a query to the embedding space. The computing system can select the dimensionally-reduced frequency-domain representation of the set of time-series information based on a difference between the dimensionally-reduced frequency-domain representation and the vector representation of the query within the embedding space.

In some implementations, the computing system can provide search result information that includes the dimensionally-reduced frequency-domain representation of the set of time-series information, at least a portion of the set of time-series information; and/or information descriptive of the set of time-series information.

In some implementations, the set of time-series information includes an array of values. Prior to applying the frequency domain transformation to the set of time-series information, the computing system can identify a first value of the array of values as being a null value. The computing system can determine an average value based on values located prior to the first value within the array of values and and/or values located subsequent to the first value within the array of values. The computing system can replace the first value with the average value.

In some implementations, prior to applying the frequency domain transformation to the set of time-series information, the computing system can perform a data stationarity test to determine that the set of time-series information is stationary.

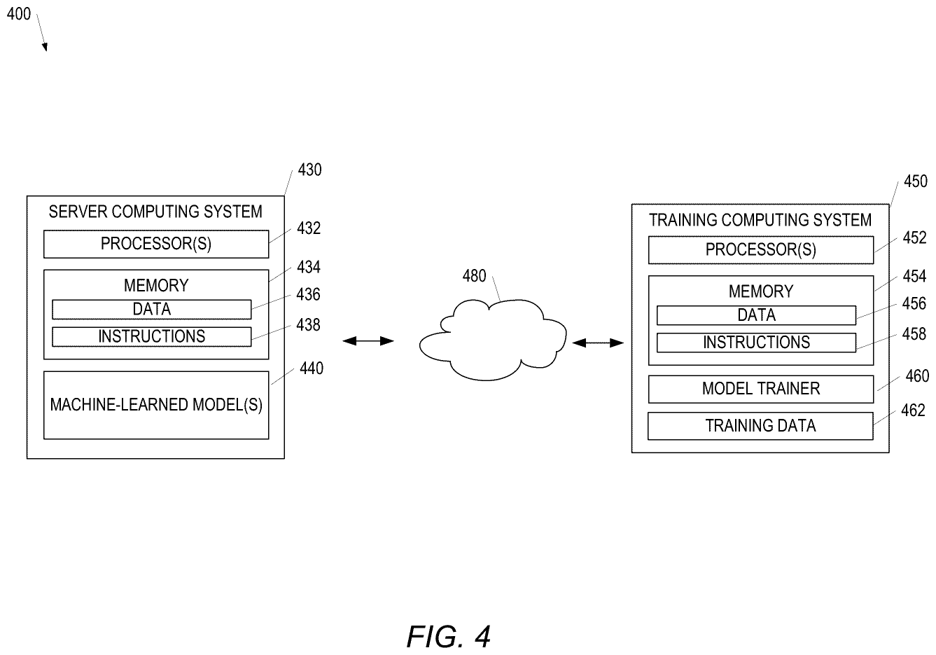

FIG. 4 depicts a block diagram of an example computing system 400 that provides vector embedding services according to example implementations of the present disclosure. The system 400 includes a server computing system 430 and a training computing system 450 that are communicatively coupled over a network 480.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage media, such as RAM, ROM, EEPROM, EPROM, flash memory devices, magnetic disks, etc., and combinations thereof. The memory 434 can store data 436 and instructions 438 which are executed by the processor 432 to cause the server computing system 430 to perform operations.

In some implementations, the server computing system 430 includes or is otherwise implemented by one or more server computing devices, virtualized computing devices, compute nodes, compute instances, etc. If the server computing system includes a plurality of computing devices, the multiple computing devices can operate according to sequential computing architectures, parallel computing architectures, or some combination thereof.

The server computing system 430 can store or otherwise include one or more machine-learned models 440. For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). In particular, the machine-learned models 440 can include foundational models with many parameters trained using large quantities of information. Examples of such models include large language models.

The server computing system 430 can train the model(s) 440 via interaction with a training computing system 450 that is communicatively coupled over the network 480. The training computing system 450 can be separate from the server computing system 430 or can be a portion of the server computing system 430.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage media. For example, the memory 454 can include RAM, ROM, flash memory devices, etc. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that is capable of training machine-learned models. Specifically, the model trainer 460 can train the machine-learned model(s) 440 implemented by the server computing system 430 using various training or learning techniques. For example, the training computing system can implement training techniques such as backwards propagation of errors. To follow the previous example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Where possible, gradient descent techniques can be used to iteratively update the parameters over a number of training iterations.

In some implementations, performing backwards propagation of errors can include performing truncated backpropagation through time. The model trainer 460 can perform a number of generalization techniques (e.g., weight decays, dropouts, etc.) to improve the generalization capability of the models being trained. The model trainer 460 can train the models 440 based on a set of training data 462. The training data 462 can include, for example, a large quantity of training information sufficient to train a foundational model to perform multiple types of tasks.

The model trainer 460 includes computer logic utilized to provide desired functionality. The model trainer 460 can be implemented in hardware, firmware, and/or software controlling a processor. For example, in some implementations, the model trainer 460 includes programmatic instructions stored on a storage device, loaded into a memory and executed by one or more processors. In other implementations, the model trainer 460 includes one or more sets of computer-executable instructions that are stored in a tangible computer-readable storage medium such as RAM, hard disk, or optical or magnetic media.

The network 480 can be any type of communications network, such as a local area network (e.g., intranet), wide area network (e.g., Internet), or some combination thereof and can include any number of wired or wireless links. In general, communication over the network 480 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. As an example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A method, comprising:
obtaining, by a computing system comprising one or more processor devices, a set of time-series information descriptive of one or more events occurring within a particular period of time;
applying, by the computing system, a frequency domain transformation to the set of time-series information to obtain a frequency-domain representation of the set of time-series information comprising a plurality of frequency components; and
determining, by the computing system, a dimensionally-reduced frequency-domain representation of the set of time-series information based at least in part on a first subset of frequency components of the plurality of frequency components.

2. The method of claim 1, wherein applying the frequency domain transformation comprises:
applying, by the computing system, a Fast Fourier Transform (FFT) to the set of time-series information to obtain the frequency-domain representation of the set of time-series information comprising the plurality of frequency components, and wherein each of the plurality of frequency components comprises a complex number pair of a corresponding plurality of complex number pairs.

3. The method of claim 2, wherein determining the dimensionally-reduced frequency-domain representation of the set of time-series information comprises:
selecting, by the computing system, the first subset of frequency components based on a frequency value of each of the first subset of frequency components, wherein the frequency value of each of the first subset of frequency components is less than a threshold frequency value.

4. The method of claim 3, wherein determining the dimensionally-reduced frequency-domain representation of the set of time-series information further comprises:
performing, by the computing system, a pairwise join to each of the complex number pairs of the first subset of frequency components to obtain the dimensionally-reduced frequency-domain representation of the set of time-series information, wherein the dimensionally-reduced frequency-domain representation comprises a one-dimensional vector of real numbers.

5. The method of claim 1, wherein the method further comprises:
mapping, by the computing system, the dimensionally-reduced frequency-domain representation to a location within an embedding space.

6. The method of claim 5, wherein the method further comprises:
mapping, by the computing system, a vector representation of a query to the embedding space; and
selecting, by the computing system, the dimensionally-reduced frequency-domain representation of the set of time-series information based on a difference between the dimensionally-reduced frequency-domain representation and the vector representation of the query within the embedding space.

7. The method of claim 6, wherein the method further comprises:
providing, by the computing system, search result information comprising one or more of:
(a) the dimensionally-reduced frequency-domain representation of the set of time-series information;
(b) at least a portion of the set of time-series information; or
(c) information descriptive of the set of time-series information.

8. The method of claim 1, wherein the set of time-series information comprises an array of values; and
wherein, prior to applying the frequency domain transformation to the set of time-series information, the method comprises:
identifying, by the computing system, a first value of the array of values as being a null value; and
determining, by the computing system, an average value based on values located prior to the first value within the array of values and and/or values located subsequent to the first value within the array of values; and
replacing, by the computing system, the first value with the average value.

9. The method of claim 1, wherein, prior to applying the frequency domain transformation to the set of time-series information, the method comprises:
performing, by the computing system, a data stationarity test to determine that the set of time-series information is stationary.

10. The method of claim 1, wherein applying the frequency domain transformation to the set of time-series information to obtain the frequency-domain representation of the set of time-series information comprises:
applying, by the computing system, one or more dimensionality reduction processes to the set of time-series information, wherein the one or more dimensionality reduction processes comprises at least one of:
a FFT;
a Principal Component Analysis (PCA); or
an Exponential Moving Average (EMA).

11. A computing system, comprising:
one or more processors; and
one or more non-transitory computer-readable media that store instructions that, when executed by the one or more processors, cause the computing system to perform operations, the operations comprising:
obtaining a set of time-series information descriptive of one or more events occurring within a particular period of time;
applying a Fast Fourier Transform (FFT) to the set of time-series information to obtain the frequency-domain representation of the set of time-series information comprising the plurality of frequency components, and wherein each of the plurality of frequency components comprises a complex number pair of a corresponding plurality of complex number pairs; and
selecting a first subset of frequency components from the plurality of frequency components based on a frequency value of each of the first subset of frequency components, wherein the frequency value of each of the first subset of frequency components is less than a threshold frequency value; and
performing a pairwise join to each of the complex number pairs of the first subset of frequency components to obtain the dimensionally-reduced frequency-domain representation of the set of time-series information, wherein the dimensionally-reduced frequency-domain representation comprises a one-dimensional vector of real numbers.

12. The computing system of claim 11, wherein the operations further comprise:
mapping the dimensionally-reduced frequency-domain representation to a location within an embedding space.

13. The computing system of claim 12, wherein the operations further comprise:
mapping a vector representation of a query to the embedding space; and
selecting the dimensionally-reduced frequency-domain representation of the set of time-series information based on a difference between the dimensionally-reduced frequency-domain representation and the vector representation of the query within the embedding space.

14. The computing system of claim 13, wherein the operations further comprise:
providing search result information comprising one or more of:
(a) the dimensionally-reduced frequency-domain representation of the set of time-series information;
(b) at least a portion of the set of time-series information; or
(c) information descriptive of the set of time-series information.

15. The computing system of claim 11, wherein:
the set of time-series information comprises an array of values; and
wherein, prior to applying the frequency domain transformation to the set of time-series information, the operations comprise:
identifying a first value of the array of values as being a null value; and
determining an average value based on values located prior to the first value within the array of values and and/or values located subsequent to the first value within the array of values; and
replacing the first value with the average value.

16. The computing system of claim 11, wherein, prior to applying the frequency domain transformation to the set of time-series information, the operations comprise:
performing a data stationarity test to determine that the set of time-series information is stationary.

17. One or more non-transitory computer-readable media that store instructions that, when executed by one or more processors of a computing system, cause the computing system to perform operations, the operations comprising:
obtaining a set of time-series information descriptive of one or more events occurring within a particular period of time;
using a Fast Fourier Transform (FFT) to convert the set of time-series information to a frequency-domain representation of the set of time-series information comprising a plurality of frequency components; and
determining a vector representation of the frequency-domain representation of the set of time-series information.

18. The one or more non-transitory computer-readable media of claim 17, wherein the frequency-domain representation of the set of time-series information comprises a plurality of frequency components, and wherein each of the plurality of frequency components comprises a complex number pair of a corresponding plurality of complex number pairs.

19. The one or more non-transitory computer-readable media of claim 17, wherein determining the vector representation of the frequency-domain representation of the set of time-series information comprises:
selecting the first subset of frequency components based on a frequency value of each of the first subset of frequency components, wherein the frequency value of each of the first subset of frequency components is less than a threshold frequency value; and
performing a pairwise join to each of the complex number pairs of the first subset of frequency components to obtain the dimensionally-reduced frequency-domain representation of the set of time-series information, wherein the dimensionally-reduced frequency-domain representation comprises a one-dimensional vector of real numbers.

20. The one or more non-transitory computer-readable media of claim 16, wherein the operations further comprise mapping the dimensionally-reduced frequency-domain representation to a location within an embedding space.
